(19) United States
(12) Patent Application Publication
(10) Pub. No.: US 2010/0205557 A1
(43) Pub. Date: Aug. 12, 2010

(54) System, method and computer-readable medium for clean up of visually displayed icons

(76) Inventor: Harold Lee Peterson, Scotts Valley, CA (US)

Correspondence Address: PATRICK REILLY, P.O. BOX 7218, SANTA CRUZ, CA, 95061-7218, US

(21) Appl. No.: 12/378,045

(22) Filed: Feb. 9, 2009

(51) Int. Cl. G06F 3/048

(52) U.S. Cl. 715/779; 715/835

(57) ABSTRACT

A system, method and computer-readable are provided for presenting visual icons on a display screen of a computer. In one aspect of the present invention, an arrangement of certain icons forms a reference display configuration. A user may then direct the hosting computer to return a desktop image back to the reference display configuration. In another optional aspect the user may either form or reconfigure the reference display configuration by capturing a configuration of a current or previous desktop image. In still another optional aspect of the invention the user may provide input to the computer information and/or commands that enable the computer to generate a first, second or other alternate display configuration.

### FIELD OF THE INVENTION

The present invention relates to the visual display of graphical user interfaces of information technology systems. More particularly, the present invention relates to the use of graphical user interfaces in organizing access to computational information.

### BACKGROUND

Information technology users have become increasingly accustomed to accessing varieties of individual software programs and content software files from graphical user interfaces. The visually displayed graphical user interface of a personal computer may include a desktop image (hereinafter “desktop”) presented in an area within, or comprising all of, the active display area of a display device. The desktop may include visually displayed icons that reference, and launch or open when selected by a user, specific software programs, software files, computational functionalities, software encoded information, and/or software encoded directories of data and/or programs. Software encoded instructions that direct and enable the computer to display the desktop may be stored within a memory location or data structure that is designated by the computer as a desktop directory, wherein the memory location or data structure may wholly or partially be stored within the computer and/or distributed within an electronics communications network, e.g., the Internet.

The multitude of information and capabilities that may be accessed or directed from a personal computer encourages many users to manage numerous software programs and content files by means of separate and unique icons that each reference a specific software program or content file. Providing computer users with graphical user interfaces that enable a user to more easily manage the presentation, or order of presentation, of pluralities of visual icons of a desktop can greatly improve a user experience of a hosting information technology system.

Content software files include media files such as audio files, video files, entertainment material, and educational curriculum. Types of software programs hosted on personal computers include programming software, system software, applications software and middleware. Programming software assists a programmer to generate software programs that may be executed by one or more types of electronic information technology systems. System software, e.g., operating system software, enables a hosting computer to function and enable choices made by a user. Application software enables a user to direct a hosting computer to accomplish specific tasks. The multitude of commercially available software applications commonly used by personal computer users includes email clients, word processors, browsers configured for exploring the World Wide Web (hereinafter “the web”), web service clients, graphic image design programs, database management systems, and electronic games.

The proliferation of software programs and content files that appeal to diverse computer users creates possibility of user's perceptual overload when icons referencing individual programs or files are presented in a multitudinous or unfamiliar pattern. There is therefore a long felt need to provide a computer user with a graphical user interface that enable the user to more effectively manage and perceive the presentation, or order of presentation, of pluralities of visual icons within a desktop.

### SUMMARY

The present invention meets the above needs and overcomes one or more deficiencies in the prior art by providing systems and methods for presenting visual icons on a display screen of a computer. In one aspect of the present invention, an arrangement of certain icons forms a reference display configuration. A user may then direct the hosting computer to return a desktop image back to the reference display configuration.

In another optional aspect the user may either form or reconfigure the reference display configuration by capturing a configuration of a current or previous desktop image. In still another optional aspect of the invention the user may provide input to the computer information and/or commands that enable the computer to generate a first, second or other alternate display configuration.

Yet other alternate preferred embodiments of the method of the present invention provide a computer-readable medium comprising machine-readable instructions which when executed by a computer cause the computer to perform one or more of the steps of the method of the present invention.

These and various other features, as well as advantages, which characterize the present invention, will be apparent from a reading of the following detailed description and a review of the associated drawings.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### INCORPORATION BY REFERENCE

All publications, patents, and patent applications mentioned in this specification are herein incorporated by reference to the same extent as if each individual publication, patent, or patent application was specifically and individually indicated to be incorporated by reference. U.S. Pat. No. 6,697,852 (Ryu, S.; issued Feb. 24, 2004) entitled “Oneclick installation for client-server application package”; U.S. Pat. No. 7,103,841 (Ronkainen, et al.; issued Sep. 5, 2006) entitled “Method and arrangement for providing an expanded desktop”; U.S. Pat. No. 7,451,407 (Brodie, et al.; issued Nov. 11, 2008) entitled “Presentation of groups of items”; and U.S. Pat. No. 7,454,700 (Jones, et al.; issued Nov. 18, 2008) entitled “Method and apparatus for restricting the application of formatting to the contents of an electronic document” are incorporated herein by reference in their entirety and for all purposes.

United States Patent Application Publication Ser. No. 20080077873 (Peterson, Harold Lee; published Mar. 27, 2008) entitled “Apparatus, method and computer-readable medium for organizing the display of visual icons associated with information technology processes”; U.S. patent application Ser. No. 09/423,025 (Peterson, H. L., et al.; filed on Oct. 28, 1999) are incorporated herein by reference in their entirety and for all purposes.

### BRIEF DESCRIPTION OF THE SEVERAL VIEWS OF THE DRAWINGS

The present invention is described in detail below with reference to the attached drawing figures, wherein:

FIG. 1 is an illustration of a video display screen of a computer, wherein a desktop comprising a cleaner icon is displayed on the video display screen;

FIG. 2 is a schematic of a computer architecture for the computer of FIG. 1;

FIG. 3 is a schematic of an electronics communications network comprising the computer of FIG. 1;

FIG. 4 is a schematic of a configuration of input devices of the computer of FIG. 1;

FIG. 5 is a flowchart of a process of certain aspects of the present invention that may be executed by the computer of FIG. 1 upon selection of the cleaner icon of FIG. 1;

FIG. 6 is a flowchart of a process of certain alternate aspects of the present invention that may be executed by the computer of FIG. 1, wherein a new desktop configuration may be recorded and/or restored;

FIG. 7 is a flowchart of a process of certain other aspects of the present invention that may be executed by the computer of FIG. 1 wherein the cleaner icon of FIG. 1 may be displayed upon selection of an enclosing icon;

FIG. 8 is a flowchart of certain still alternate aspects of the present invention that may be executed by the computer of FIG. 1 wherein a desktop configuration is restored;

FIG. 9 is a flowchart of certain even other alternate aspects of the present invention that may be executed by the computer of FIG. 1 wherein a software application, media file or data collection may be downloaded by the computer from the network of FIG. 3; and

FIG. 10 is an illustration of an exemplary first desktop configuration record of FIG. 5.

### DETAILED DESCRIPTION

The present invention provides an improved system, method and computer-readable medium for the management of the visual presentations of icons by a computer. An exemplary operating environment for the present invention is described below. The subject matter of the present invention is described with specificity to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

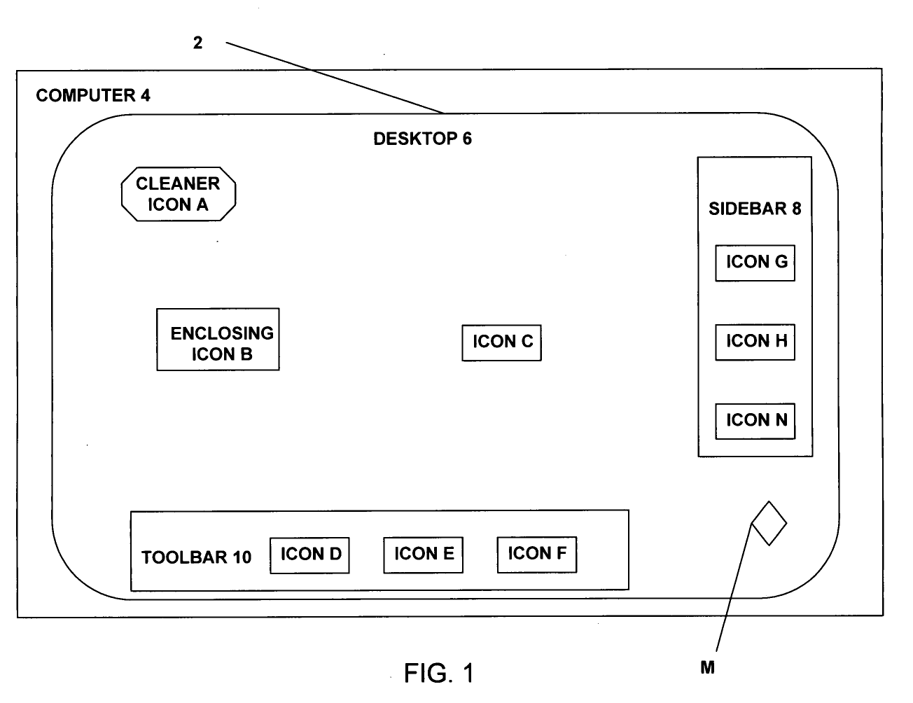

Referring now to the attached drawings, which are incorporated in their entirety by reference herein and in which like numerals represent like elements, various aspects of the present invention will be described. In particular, FIG. 1 and the corresponding discussion are intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 1 is an illustration of a video display screen 2 of a computer 4, wherein a desktop 6 is displayed on the video display screen 2 (hereinafter “screen” 2) and comprises visual displays of a sidebar 8, a toolbar 10, a cleaner icon A, a plurality of icons B-N, and a cursor M. It is understood that the cleaner icon A may be presented within either the toolbar 10 or the sidebar 8.

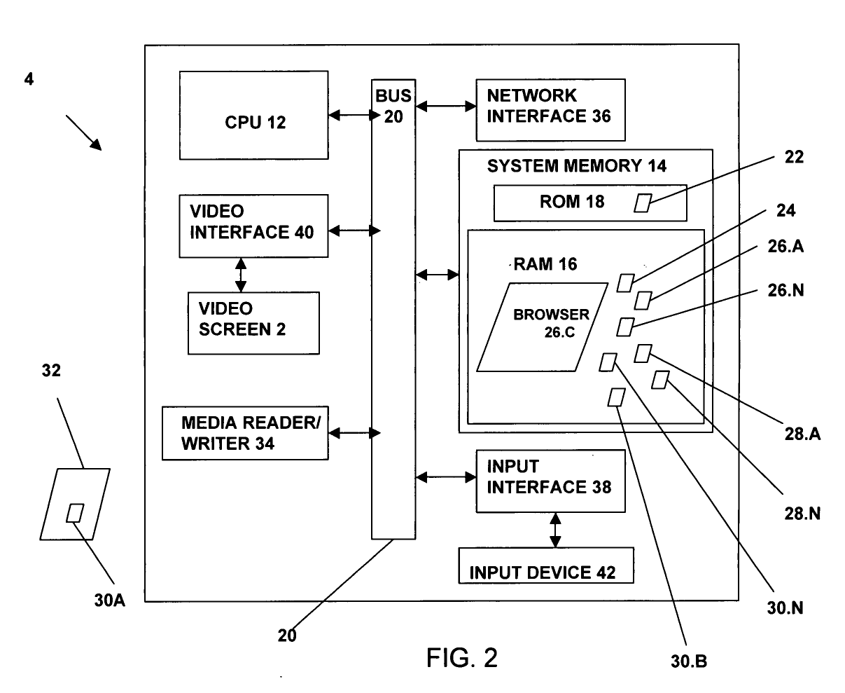

Referring now to FIG. 2, an illustrative computer architecture for the computer 4 utilized in the various embodiments of the invention will be described.

The computer 4 may be or comprise a computer system, such as (a.) a VAIO FS8900™ notebook computer marketed by Sony Corporation of America, of New York City, N.Y., (b.) a SUN SPARCSERVER™ computer workstation marketed by Sun Microsystems of Santa Clara, Calif. running LINUX™ or UNIX™ operating system; (c.) a personal computer configured for running WINDOWS XP™ or VISTA™ operating system marketed by Microsoft Corporation of Redmond, Wash.; (d.) a PowerBook G4™ personal computer as marketed by Apple Computer of Cupertino, Calif.; (e.) an iPhone™ cellular telephone as marketed by Apple Computer of Cupertino, Calif.; or (f.) a personal digital assistant enabled for wireless communications.

The computer architecture shown in FIG. 2 illustrates a conventional desktop or laptop computer 4, including a central processing unit 12 (“CPU”), a system memory 14, including a random access memory 16 (“RAM”) and a read-only memory (“ROM”) 18, and a system bus 20 that couples the system memory 14 to the CPU 12. A basic input/output system 22 containing the basic software-encoded instructions and routines that help to transfer information between elements within the computer 4, such as during startup, is stored in the ROM 18. The computer 4 further includes an operating system 24, application programs 26.A-26.N, media files 28.A-28.N, and data collections 30.A-30.N, which will be described in greater detail below, in the system memory and/or a computer-readable medium 32.

A media writer/reader 34 is bi-directionally communicatively coupled to the CPU 12 through the bus 20. The media writer/reader 34 and the associated computer-readable media 32 are selected and configure to provide non-volatile storage for the computer 4. Although the description of computer-readable media 32 contained herein refers to a mass storage device, such as a hard disk or CD-ROM drive, it should be appreciated by those skilled in the art that computer-readable media can be any available media that can be accessed by the computer 4.

By way of example, and not limitation, computer-readable media 32 may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 4.

The computer-readable medium 32 may comprise machine-readable instructions which when executed by the computer to cause the computer 4 to perform one or more steps as described in the Figures and enabled by the present disclosure.

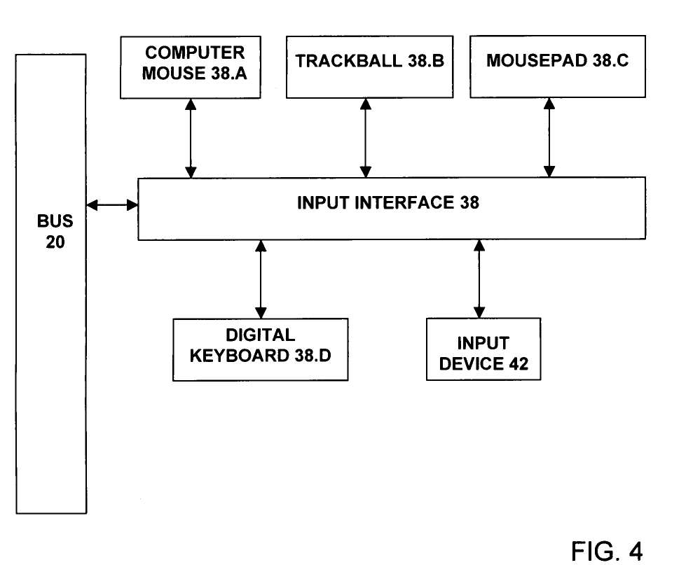

The bus 20 further bi-directionally communicatively couples a network interface 36, an input interface 38, and a video screen interface 40 with the CPU 12 and the system memory 14. The input interface 38 communicatively couples one or more input devices 38.A-38.D and/or 42 as described in FIG. 4 below. The video screen interface 40 bi-directionally communicatively couples the video screen 2 to the CPU 12 and the system memory 14 via the bus 20.

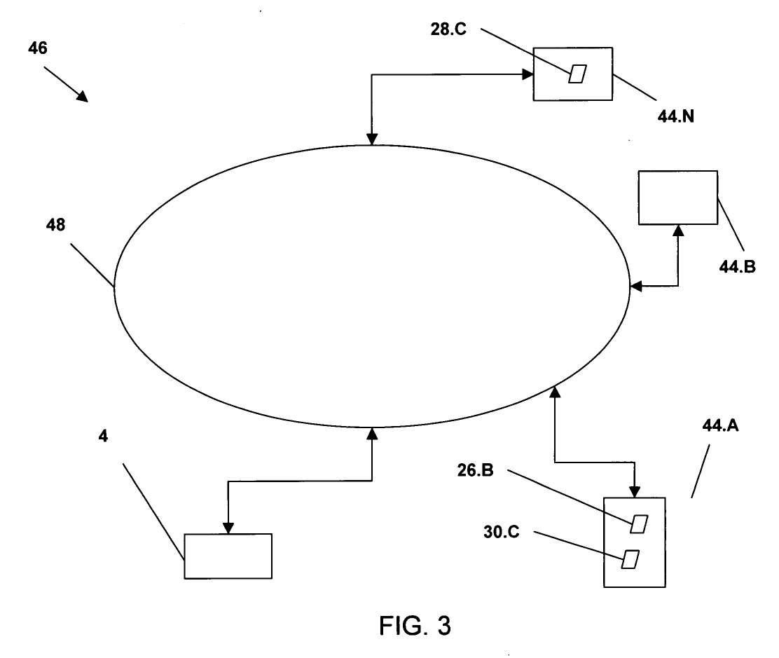

Referring now generally to the Figures and particularly to FIG. 3, according to various aspects of the invention, the computer 4 may operate in a networked environment using logical connections to remote computers 44.A-44.N, such as an e-mail server computer 44.B, through the network 46, such as the Internet 48. The computer 4 may connect to the network 46 through the network interface 36 connected to the bus 20. It should be appreciated that the network interface 36 may also be utilized to connect to other types of networks and remote computer systems 44.A-44.N.

As mentioned briefly above, a number of application software 26,A-26.N, media files 28.A-28.N and/or data files 30.A-30.N may be stored in computer-readable medium 32 and/or the system memory 14 of the computer 4, including an operating system 22 suitable for controlling the operation of a networked personal computer, such as the WINDOWS XP operating system marketed by MICROSOFT CORPORATION of Redmond, Wash. Furthermore, one or more application software 26,A-26.N, media files 28.A-28.N and/or data files 30.A-30.N may be distributively stored through out the network 46, the computer 4, and/or the remote servers 44.A-44.N.

Referring now generally to the Figures and particularly to FIG. 4, according to various aspects of the invention, the input interface 38 communicatively couples one or more input devices 38.A-38.D, to include an icon selection device 38.A, 38.B, 38.C, 38.D and 42, such as a computer mouse 38.A, a trackball 38.B, a mouse pad 38.C, a digital keyboard 38.D and/or an electronic stylus 42, to the CPU 12, the video interface 40 and the system memory 14 via the bus 20.

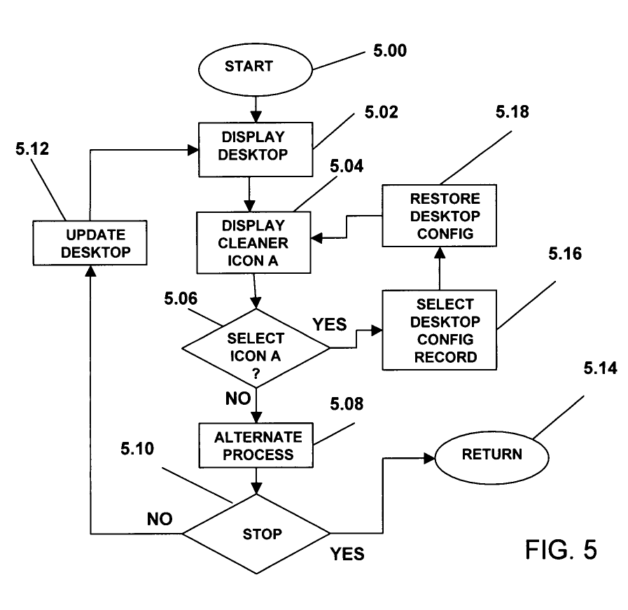

Referring now generally to the Figures and particularly to FIG. 5, FIG. 5 is a flowchart of a process of certain aspects of the present invention, wherein the computer 4 is powered up in step 5.00, and displays the desktop 6 on the screen 2 in step 5.02. The computer 4 proceeds from step 5.03 to step 5.04 and to display the cleaner icon A. The computer 4 determines in step 5.06 whether the computer 4 has received a command selecting the cleaner icon A via a user input received from either the network 46 or an input device 38.A-38.D or 42. When the computer 4 determines in step 5.06 that the computer 4 has not received an unexecuted command selecting the cleaner icon A, the computer 4 proceeds from step 5.06 to step 5.08 and to perform alternate computational processes.

The computer 4 then determines in step 5.10 whether the computer 4 has received a command, via a user input received from either the network 46 or an input device 38.A-38.D or 42, to exit the processing loop of steps 5.02 through 5.12. When the computer 4 determines in step 5.10 that the computer 4 has not received an unexecuted command to exit the loop 5.02 through 5.12, the computer 4 proceeds from step 5.10 to step 5.12 to update the desktop 6 on the basis of the alternate computational processes of step 5.10. When the computer 4 determines in step 5.10 that the computer 4 has received an unexecuted command to exit the loop 5.02 through 5.12, the computer 4 proceeds from step 5.10 to step 5.14 to return to alternate computational processing, and optionally to return to step 5.02 and/or power down.

When the computer 4 determines in step 5.06 that the computer 4 has received an unexecuted command selecting the cleaner icon A, the computer 4 proceeds from step 5.06 to step 5.16 to select a desktop configuration record 50.A-50.N. In step 5.18 the desktop 6 is restored to a visual configuration as derived from the desktop configuration record 50.A-50.N selected in step 5.16.

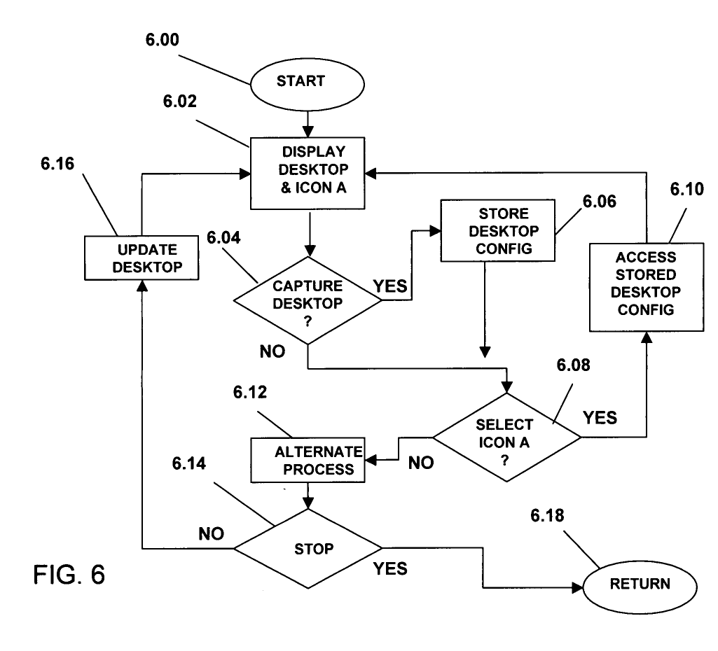

It is understood that the display of the cleaner icon A of step 5.04 may be included in the execution of step 5.02 and/or step 5.18. Referring now generally to the Figures and particularly to FIG. 6, FIG. 6 is a flowchart of a process of certain alternate aspects of the present invention, wherein the computer 4 is powered up in step 6.00, and displays the desktop 6 on the screen 2 and the cleaner icon A in step 6.02. The computer 4 determines in step 6.04 whether the computer 4 has received a command via the network 46 and/or an input device 38.A-38.D or 42 to generate or update a configuration record 50.A-50.N. When the computer 4 determines in step 6.04 that an unexecuted command to restore the desktop 6 to a previously stored configuration has been received via the network 46 and/or an input device 38.A-38.D or 42 directing the computer 4 to generate or update a configuration record 50.A-50.N, the computer proceeds from step 6.04 to step 6.06. The computer 4 generates or updates a configuration record 50A-50N in step 6.06, wherein the selected the newly generated or updated configuration record 50.A-50.N stores a representation of the current image of the desktop 6 with which the computer 4 may later restore the screen 2 to display the desktop 6 as configured at the time of the update or generation of the newly updated or generated configuration record 50A-50N. The computer 4 proceeds from either step 6.04 Or step 6.06 to step 6.08.

The computer 4 determines in step 6.08 whether the computer 4 has received a command via the network 46 and/or an input device 38.A-38.D or 42 directing the computer 4 to restore the desktop 6 according to a previously updated or generated configuration record 50.A-50.N. When the computer 4 determines in step 6.08 that an unexecuted command to restore the desktop 6 to a previously stored configuration has been received, the computer 4 proceeds from step 6.08 to step 6.10 and to restore the desktop 6 according to the information stored in a selected configuration record 50.A-50.N.

When the computer 4 determines in step 6.08 that an unexecuted command to restore the desktop 6 to a previously stored configuration has not been received, the computer 4 proceeds from step 6.08 to step 6.10 and to perform alternate computational processing.

The computer 4 proceeds from step 6.12 to step 6.14 and to determine whether the computer 4 has received an unexecuted command via the network 46 and/or an input device 38.A-38.D or 42 to exit the loop 6.02 through 6.16. When the computer 4 determines in step 6.14 to not have received an unexecuted command to exit the loop 6.02 through 6.16, the computer 4 proceeds from step 6.14 to step 6.16 and to update the desktop 6 as a consequence of the computational processes and activity of the computer 4 of the steps 6.02 through 6.12.

When the computer 4 determines in step 6.14 to have received an unexecuted command to exit the loop 6.02 through 6.16, the computer 4 proceeds from step 6.14 to step 6.18 and to return to alternate computational processing, and optionally to return to step 5.02 or 6.02 and/or to power down.

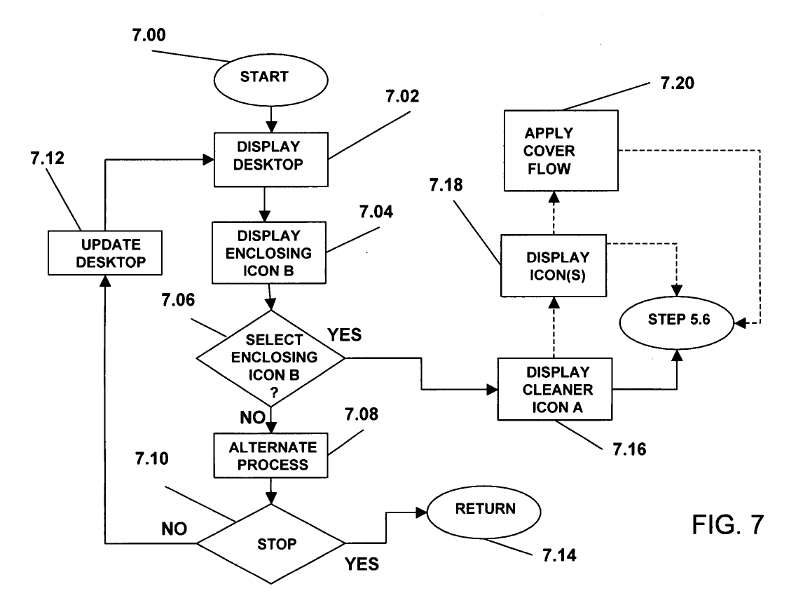

Referring now generally to the Figures and particularly to FIG. 7, FIG. 7 is a flowchart of a process of certain other aspects of the present invention, wherein the computer 4 is powered up in step 7.00, and displays the desktop 6 on the screen 2 in step 7.02. The computer 4 displays an enclosing icon B in step 7.04 in an enclosing state. The enclosing icon B visually presents within the desktop 6 either an enclosed state or an opened state, wherein the cleaner icon A is presented on the video screen 2 in addition to one or more icons C-N when the enclosing icon is in the opened state.

The computer 4 determines in step 7.06 whether the computer 4 has received a command via a user input received from either the network 46 or an input device 38.A-38.D or 42 selecting the enclosing icon B. When the computer 4 determines in step 7.06 that the computer 4 has not received an unexecuted command selecting the enclosing icon B, the computer 4 proceeds from step 7.06 to step 7.08 and to perform alternate computational processes.

The computer 4 then determines in step 7.10 whether the computer 4 has received a command, via a user input received from either the network 46 or an input device 38.A-38.D or 42, to exit the processing loop of steps 7.02 through 7.12. When the computer 4 determines in step 7.10 that the computer 4 has not received an unexecuted command to exit the loop 7.02 through 7.12, the computer 4 proceeds from step 7.10 to step 7.12 to update the desktop 6 on the basis of the alternate computational processes of step 7.10. When the computer 4 determines in step 7.10 that the computer 4 has received an unexecuted command to exit the loop 7.02 through 7.12, the computer 4 proceeds from step 7.10 to step 7.14 to return to alternate computational processing, and optionally to return to steps 5.02, 6.02, 7.02 and/or power down.

When the computer 4 determines in step 7.06 that the computer 4 has received an unexecuted command selecting the enclosing icon B, the computer 4 proceeds from step 7.06 to step 7.16 to select to display the cleaner icon A. In optional step 7.18 the computer 4 visually displays additional icons B-N associated with the enclosing icon B. In optional step 7.20 the computer 4 visually displays the cleaner icon A and one or more additional icons B-N in a cover flow presentation.

The computer 4 proceeds from step 7.16, 7.18 or 7.20 to return to execute step 5.6.

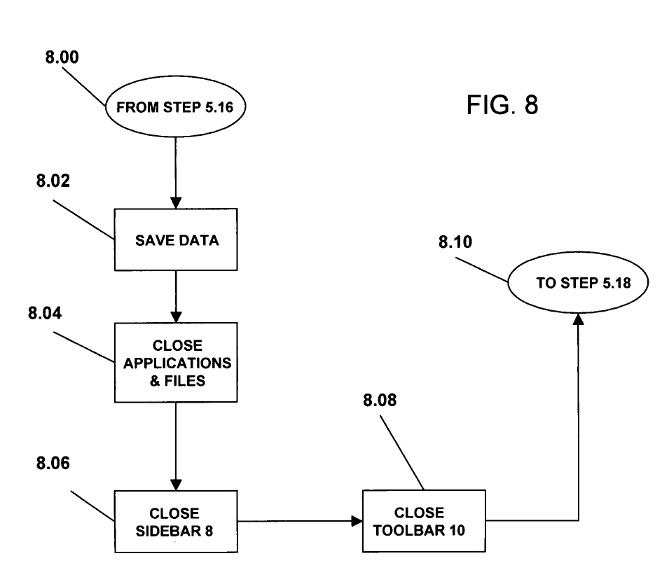

Referring now generally to the Figures and particularly to FIG. 8, FIG. 8 illustrates a flowchart of certain still alternate aspects of the present invention. The computer 4 proceeds from step 5.16 to step 8.02 wherein the computer 4 saves data entered into open documents, e.g., a word processor document may be updated to include recent text editing input. In step 8.04 software applications 26.A-26.N, media files 28.A-28.N and data collections 30.A-30.N are closed. In step 8.06 the sidebar 8 may be closed, and in step 8.08 the toolbar 10 may be closed. The computer 4 proceeds from step 8.08 and to step 5.18.

It is understood that the actions of computer 4 of steps 8.02 through 8.08 are made in accordance with information stored in the configuration record 50.A-50.N, wherein the configuration record 50.A-50.N may direct the computer 4 to restore the desktop 6 to a state wherein one or more software applications 26.A-26.N, media files 28.A-28.N and data collections 30.A-30.N are maintained as open or restored to an open state in step 5.18. It is further understood that the configuration record 50.A-50.N may direct the computer 4 to restore the desktop 6 to a state wherein the sidebar 8 and/or the toolbar 10 may be visually presented on the display 2 in step 5.18

The term “open” indicates as applied to a sidebar 8, a toolbar 10, a software application 26.A-26.N, a media file 28.A-28.N and a data collection 30.A-30.N as being visually represented, executed, instantiated, or available for access or modification.

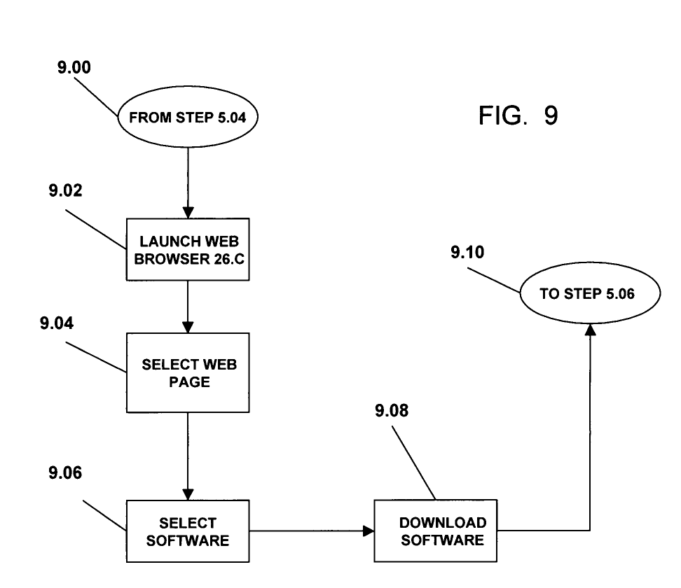

Referring now generally to the Figures and particularly to FIG. 9, FIG. 9 illustrates a flowchart of certain yet alternate aspects of the present invention, wherein a software, e.g. a second software application 26.B, a second media file 28.C or an external data collection 30.C, may be downloaded from the network 46. In step 9.02 the computer 4 launches the web browser 26.C as directed from the user via one or more input devices 38.A-38.D and/or 42. The user selects a web page in step 9.04, and selects software for download in step 9.06. The computer 4 downloads the selected software, e.g. a second software application 26.B, a second media file 28.C or an external data collection 30.C and proceeds on from step 9.08 to step 5.06.

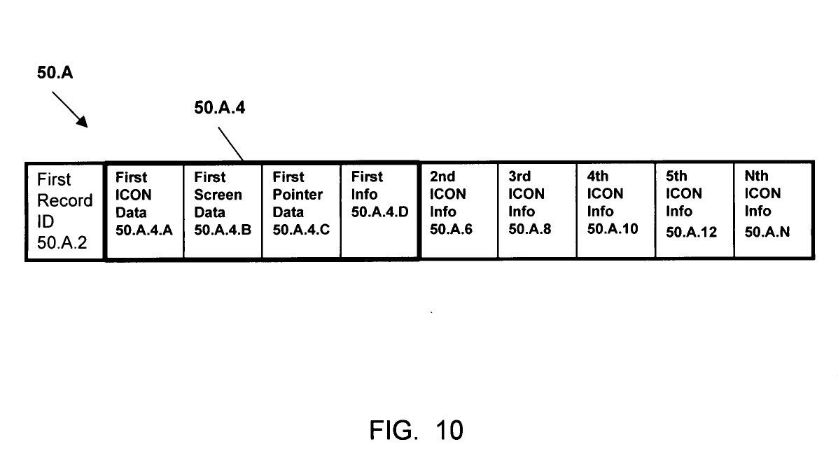

Referring now generally to the Figures and particularly to FIG. 10, FIG. 10 is an illustration of an exemplary first desktop configuration record 50.A. The first configuration record 50.A is a software-encoded record that may be stored in the system memory 14, or the computer-readable medium 32, or within the network 46.

The first configuration record 50.A includes a first record identifier 50.A.2 and a plurality of first icon information sets 50.A.4-50.N. An exemplary first icon information set 50.A.4 includes a first icon data 50.A.4.A, a first screen location information 50.A.4.B, a first pointer data 50.A.4.C, and a first information payload 50.A.4.D. The first icon data 50.A.4.A contains information that is read by the computer 4 to determine how to present an exemplary icon C on the screen 2 and within the desktop 6. The first screen location information 50.A.4.B contains information that is read by the computer 4 to determine where, and in what orientation, to present the exemplary icon C on the on the screen 2 and within the desktop 6. A first pointer data 50.4.C includes information that directs the computer 4 on a memory location accessible to the computer 4 where executable code of a software program that is associated with the exemplary icon C is stored, whereby selection of the exemplary icon C by an icon selection device 38.A, 38.B, 38.C, 38.D and 42 directs the computer 4 to initiate execution of software-encoded instructions of the software program stored at the memory location indicated by the first pointer data 50.4.C. The first information payload 50.A.4.D includes information associated with a software program, wherein the software program may be selected from the plurality application programs 26.A-26.N, media files 28.A-28.N, and data collections 30.A-30.N as stored in whole or in part in the system memory 14, the medium 32, and the network 46.

It is understood that one or more of the icon information sets 50.A.4-50.N may contain information that directs the computer 4 to display the sidebar 8 and/or the toolbar 10, wherein the visual presentation of the sidebar 8 and/or the toolbar 10 includes one or more icons A through N

Based on the foregoing, it should be appreciated that the various embodiments of the invention include a method, system, apparatus, and computer-readable medium for managing the presentation of icons within a desktop. The above specification, examples and data provide a complete description of the manufacture and use of the composition of the invention. Since many aspects of the invention can be generated without departing from the spirit and scope of the invention, the invention resides in the claims hereinafter appended. Alternative embodiments and implementations of the present invention will become apparent to those skilled in the art to which it pertains upon review of the specification, including the drawing figures. Accordingly, the scope of the present invention is defined by the appended claims rather than the foregoing description.

I claim:

1. In a computer having a video display and an icon selection device, a method for restoring a plurality of icons to a reference display configuration, the method comprising:
displaying the plurality of icons by means of the video display;
displaying a cleaner icon;
reception by the computer of a selection of the cleaner icon by means of the icon selection device; and
restoring the plurality of icons to the reference display configuration

2. The method of claim 1, further comprising:
reception by the computer of a restore command; and
restoring the plurality of icons to a previous display configuration.

3. The method of claim 3, wherein the previous display configuration is a second reference display configuration.

4. The method of claim 1, further comprising:
reception by the computer of a reference display configuration capture command; and
storing a machine-readable description of a contemporaneous display of the plurality of icons as;
reception by the computer of a selection of the cleaner icon by means of the icon selection device; and
restoring the plurality of icons to an updated reference display configuration as described by the stored machine-readable description.

5. The method of claim 1, wherein the computer further includes an enclosing icon software code configured to present an enclosing icon on the video display alternately in an open state and in an enclosing state, and the method further comprising instantiating the enclosing icon in an enclosing state after reception by the computer of a selection of the cleaner icon.

6. The method of claim 5, further comprising the computer instantiating the enclosing icon in an open state after reception by the computer of a selection of the enclosing icon.

7. The method of claim 6, further comprising the computer instantiating a cover flow of at least two icons associated with the enclosing icon in an instantiation of the enclosing icon in an open state.

8. The method of claim 1, further comprising maintaining at least one applications software program in an enabled state in the process of restoring the plurality of icons to the reference display configuration.

9. The method of claim 1, further comprising presenting an icon of at least one applications software program within a toolbar in the process of restoring the plurality of icons to the reference display configuration.

10. The method of claim 1, further comprising closing at least one applications software program in the process of restoring the plurality of icons to the reference display configuration.

11. The method of claim 1, further comprising removing a visual representation by the video screen of a toolbar in the process of restoring the plurality of icons to the reference display configuration.

12. The method of claim 8, wherein the computer is bi-directionally communicatively coupled with the Internet and the at least one applications software program is downloaded from the Internet to the computer prior to the reception by the computer of a selection of the cleaner icon by means of the icon selection device.

13. The method of claim 1, wherein icon selection device is selected from the device group consisting of a computer mouse, a mouse pad, and a trackball.

14. The method of claim 1, wherein icon selection device is a keyboard.

15. The method of claim 14, wherein the cleaner icon selection is actuated by a depression of a single key of the keyboard.

16. The method of claim 14, wherein the cleaner icon selection is actuated by a depression of at least two keys of the keyboard.

17. A computer comprising:
means to visually display plurality of icons and a cleaner icon;
means to receive a selection of the cleaner icon a user; and
means to restoring the plurality of icons to a reference display configuration upon receipt of the selection of the cleaner icon.

18. The computer of claim 17, wherein the means to receive a selection of the cleaner icon a user comprises an input-output device selected from the input-output group of a keyboard, a computer mouse, a mouse pad, and a trackball.

19. The computer of claim 17, wherein the computer further comprises means to download an applications program, the applications program configured to enable the computer to generate at least one visual icon.

20. A computer-readable medium comprising machine-readable instructions which when executed by a computer system cause the computer to perform a method comprising:
display a plurality of icons and a cleaner icon by means of the video display;
receive a selection of the cleaner icon by means of an icon selection device; and
restore the plurality of icons to a reference display configuration.
